(19) United States
(12) Patent Application Publication
(10) Pub. No.: US 2022/0284371 A1
(43) Pub. Date: Sep. 8, 2022

(54) METHOD, DEVICE AND MEDIUM FOR A BUSINESS FUNCTION PAGE

(71) Applicant: BOE TECHNOLOGY GROUP CO., LTD., Beijing (CN)

(72) Inventors: Weiguang GAO, Beijing (CN); Yan LU, Beijing (CN); Haixia ZHAO, Beijing (CN)

(21) Appl. No.: 17/513,351

(22) Filed: Oct. 28, 2021

(30) Foreign Application Priority Data
Mar. 3, 2021 (CN) 202110235682.4

(51) Int. Cl. G06Q 10/06; G06F 40/186

(52) U.S. Cl. CPC G06Q 10/06375; G06F 40/186

(57) ABSTRACT

This application discloses a method, apparatus, device and medium for a business function page. The method receives a data element contained in a target business function page which is inputted, receives a function component contained in the target business function page which is inputted, and receives a first operation which is inputted, and in response to the first operation, generates the target business function page corresponding to a target business function according to a business element component association table. The business element component association table is obtained by filling an association template according to an association relationship between data elements contained in a business data table and function components, and the business data table is generated according to the data elements.

### RELATED APPLICATIONS

The present application claims the benefit of Chinese Patent Application No. 202110235682.4, filed on Mar. 3, 2021, the entire disclosure of which is incorporated herein by reference.

### TECHNICAL FIELD

The application relates to the technical field of computer processing, and in particular, to a method, apparatus, device and medium for a business function page.

### BACKGROUND

An intelligent bank is an advanced stage of a traditional bank and a network bank, and is a target and means with which a bank enterprise examines its own needs with intelligentized means and new thinking mode, and utilizes innovative technologies to shape new services, new products, new operation and business modes, realize economies of scale, improve the efficiency and reduce the cost, and achieve effective management and efficient marketing performance.

With the development of the intelligent bank, branch business of the intelligent bank tends to be personalized, and different branches may determine their corresponding business needs according to a big data platform. For different business needs, different pages need to be provided for implementation. However, nowadays, the efficiency of development of such a page is too low and cannot meet the development needs of intelligent bank branches that rapidly increase.

### SUMMARY

In an aspect, an embodiment of this application provides a method for a business function page, which method comprises:

receiving a data element contained in a target business function page which is inputted;

receiving a function component contained in the target business function page which is inputted; and

receiving a first operation which is inputted, and in response to the first operation, generating the target business function page corresponding to a target business function according to a business element component association table, the business element component association table being obtained by filling an association template according to an association relationship between data elements contained in a business data table and function components, and the business data table being generated according to the data elements.

In an aspect, an embodiment of this application provides an apparatus for generating a business function page, which apparatus comprises:

a data element configuration module for receiving a data element contained in a target business function page which is inputted;

a function component configuration module for receiving a function component contained in the target business function page which is inputted; and

a page generation module for receiving a first operation which is inputted, and in response to the first operation, generating the target business function page corresponding to a target business function according to a business element component association table, the business element component association table being obtained by filling an association template according to an association relationship between data elements contained in a business data table and function components, and the business data table being generated according to the data elements.

In an aspect, an embodiment of this application provides an electronic device comprising a memory, a processor and a computer program which is stored on the memory and may be run on the processor, and when executing the program, the processor implements the method as described in the embodiments of this application.

In a sixth aspect, an embodiment of this application provides a computer readable storage medium storing a computer program thereon for implementing the method as described in the embodiments of this application.

### BRIEF DESCRIPTION OF THE DRAWINGS

Other features, objects and advantages of this application will become more evident by reading a detailed description of non-limiting embodiments made with reference to the following drawings:

FIG. 1 shows a schematic diagram of an application scenario of a method for generating a business function page provided by an embodiment of this application;

FIG. 2a shows a flow diagram of a method for generating a business function page proposed by an embodiment of this application;

FIG. 2b shows a flow diagram of obtaining a business element component association table proposed by an embodiment of this application;

FIG. 2c shows a flow diagram of generating a business data table proposed by an embodiment of this application;

FIG. 3 shows a schematic diagram of a management and control configuration interface proposed by an embodiment of this application;

FIG. 4 shows a flow diagram of a further method for generating a business function page proposed by an embodiment of this application;

FIG. 5a shows a flow diagram of a method for applying a business function page proposed by an embodiment of this application;

FIG. 5b shows a flow diagram of generating a query statement proposed by an embodiment of this application;

FIG. 6 shows a schematic diagram of implementing a specific configuration on a management and control configuration interface proposed by an embodiment of this application;

FIG. 7 shows a schematic diagram of a result of generating a business function page proposed by an embodiment of this application;

FIG. 8 shows a structure diagram of an apparatus for generating a business function page proposed by an embodiment of this application; and

FIG. 9 shows a structure diagram of a processing system of an electronic device proposed by an embodiment of this application.

### DETAILED DESCRIPTION

In the following the application will be further described in detail in conjunction with the drawings and embodiments. It may be appreciated that the specific embodiments described herein are merely used for explaining the related disclosure, but not limiting the disclosure. In addition, it further needs to be noted that only those parts related with the disclosure are shown in the drawings for the convenience of description.

It needs to be noted that, in the absence of conflict, the embodiments in this application and the features in the embodiments may be combined with each other. In the following, the application will be described in detail with reference to the drawings and in conjunction with the embodiments.

In the following, an implementing environment involved in a method for a business function page provided by an embodiment of this application will be introduced first. Reference is made to FIG. 1, which shows a schematic diagram of an application scenario of a method for a business function page provided by an embodiment of this application.

As shown in FIG. 1, the implementing environment comprises a terminal 101 and a server 103. Therein, the type of the terminal 101 comprises, without limitation, a smart phone, a desktop computer, a laptop, a tablet, a wearable device, etc., and the terminal may be installed with various applications, for example, a management and control platform for implementing a financial business, which will not be specifically limited by the embodiment of this application.

In the embodiment of this application, the terminal 101 is used for receiving a configuration parameter inputted by a user and sending the configuration parameter to the server 103 via a network 102, and the server 103 is used for returning a result corresponding to the configuration parameter to the terminal 101 according to the configuration parameter sent by the terminal 101, and in turn the terminal 101 shows the result to the user.

The server may be a separate server, or a server cluster consisting of several servers, or a cloud computing center. The server can provide the terminal with a query processing service. The server may be a background server for an application. For example, the server may be an intermediate server, and the terminal may interact with the server via an application, thereby implementing a query processing flow. The terminal may interact with the server in a wired or wireless manner, thereby implementing the query processing flow.

The method for a business function page provided by the embodiment of this application may be performed by an apparatus for generating a business function page as an execution body. The apparatus for generating a business function page may be integrated into a computer device such as the terminal or the server or the like, and the apparatus for generating a business function page may be hardware or also may be a software module. The method may also be performed by a single terminal or server, or performed by the two in cooperation.

In the related art, configuration of a business function page needs to invest a lot of human and financial resources with respect to respective unique needs. For example, during the development of branch businesses of an intelligent bank, the needs for a business function for some branches may be larger, and if the business function is developed separately for the branches, it is needed for developers to develop a page corresponding to the business function again, which results in increase in human cost and a lower development efficiency. To solve this problem, this application proposes a method for a business function page, which may use requirements for a variety of different business scenarios and improve the efficiency of developing a page.

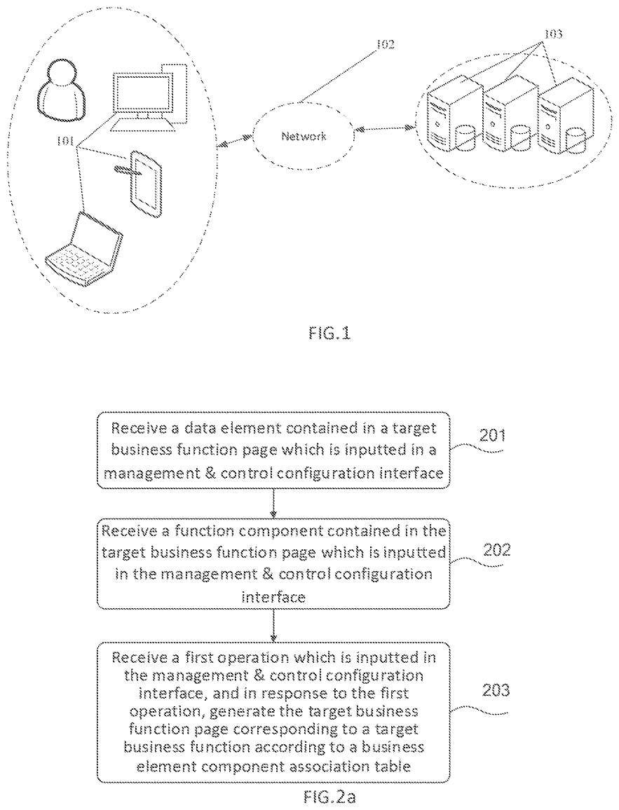

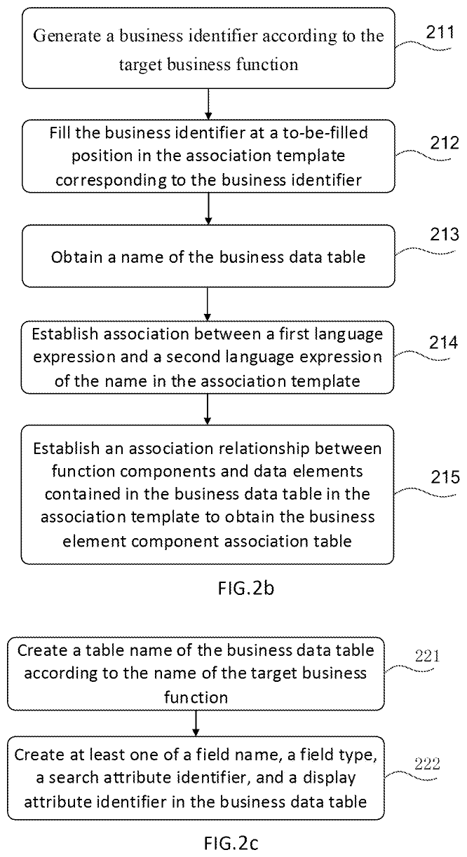

In the following, reference is made to FIG. 2a, which shows a flow diagram of a method for generating a business function page proposed by an embodiment of this application. As shown in FIG. 2a, the method may be performed by an apparatus for generating a business function page, and the apparatus for generating a business function page may be configured in a server. The method comprises:

step 201, receiving a data element contained in a target business function page which is inputted;

step 202, receiving a function component contained in the target business function page which is inputted; and

step 203, receiving a first operation which is inputted, and in response to the first operation, generating the target business function page corresponding to a target business function according to a business element component association table.

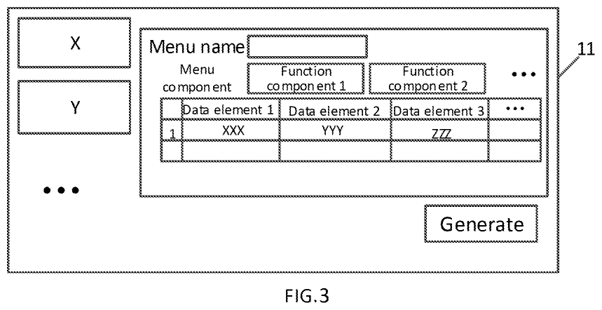

The data element, the function component and the first operation received at the above individual steps may be inputted in a management and control configuration interface as shown in FIG. 3.

At the above steps, the business element component association table is obtained by filling an association template according to an association relationship between data elements contained in a business data table and function components, wherein the business data table is generated according to the data elements. The association template refers to a pre-configured empty template corresponding to the business element component association table, and the association template comprises, but is not limited to, one or more to-be-filled position, for example, a to-be-filled position corresponding to a business identifier, a to-be-filled position corresponding to a name of the business data table, a to-be-filled position of a Chinese name corresponding to an individual field in the business data table, a to-be-filled position corresponding to a field type, and a to-be-filled position corresponding to a function component.

At the above steps, the target business function page refers to a page corresponding to a business function in a management and control platform. The business function refers to a collection comprising one or more function component for implementing a specific business operation. Taking a financial management function of some branch of an intelligent bank as an example, a function component required for the financial management function comprises, but is not limited to, one such as query, delete, add or upload and download, etc., and a financial management function page is a page comprising, without limitation, the above-mentioned function components, such as a page as shown in FIG. 7.

The target business function page comprises, without limitation, one or more data element, one or more function component. The data element refers to information such as a text, a picture, an animation, music, a program, etc. displayed in a page. The function component refers to a component corresponding to a function to be implemented in a management and control page of a bank, for example, a query function component, a delete function component, an add function component, an upload and download function component, an examination and approval function component, etc. Here, the specific type of the function component will not be limited.

The management and control configuration interface refers to a configuration interface for configuring a target business function page shown on a management and control platform.

As shown in FIG. 3, the management and control configuration interface 11 comprises a data element input area and a function component input area for generating a target business function page. The two input areas may for example comprise a preset selection item, or also may comprise an input box so as to input a data element and a function component required for a target management and control page in the input box.

On the management and control configuration interface 11, a person who performs a configuration task, for example, a page developer, inputs a first operation on the management and control configuration interface, and the first operation comprises, but is not limited to, a click operation or a touch operation. The first operation is used for triggering generation of a target business function page. For example, a “generate” touch control is configured on the management and control configuration interface 11. When the user clicks the “generate” touch control, it indicates generating a target business function page corresponding to a configuration parameter in the management and control configuration interface according to the configuration parameter.

In response to the first operation, the target business function page is generated according to a business element component association table.

The business element component association table is obtained by filling an association template according to an association relationship between data elements contained in a business data table and the function components.

Before filling the association template, the business data table is generated according to the data element inputted in the management and control configuration interface, and a name of the business data table is determined according to a name of the target business function inputted by the user. For example, the user expects to create a management and control interface for some branch of an intelligent bank, the interface comprises multiple business functions, one of them is financial management, then the user inputs the name of the business function as “financial management” in the management and control configuration interface, and it may also be understood that the menu name corresponding to the business function is “financial management”. A name of the business data table corresponding to “financial management” is accordingly converted into an English abbreviation expression, for example, “Finan”.

Therein, as shown in FIG. 2c, generating the business data table according to the data elements comprises:

step 221, creating a table name of the business data table according to the name of the target business function; and

step 222, creating a field name, a field type, a search attribute identifier, and a display attribute identifier in the business data table.

For example, after receiving a data element inputted by the user in the management and control configuration interface, the business data table is generated based on the data element, and the business data table comprises a table name of the business data table, a field name, a data type, is it empty, data dictionary, is there a search condition, does it display a list, or the like.

The business data table corresponding to the target business function page further comprises for example multiple data elements obtained from the management and control configuration interface, for example, a field name, a field type, a function component, and so on. The field name is data content shown in the target business function page. For example, the financial management function needs to show data content such as a name of a product, an issue date, etc., and each filed name is used for representing a page element to be shown in the target business function page.

The field type refers to a representation type of data corresponding to the filed name. The representation type comprises, but is not limited to, an integer type, a character type, a decimal type, and so on.

The function component refers to a component contained in the target business function page for providing the user with a human-machine interaction interface, for example, a query component, a page turning component, an upload and download component, and so on.

After generating the business data table, data in the business data table is utilized to fill the association template, thereby obtaining the business element component association table corresponding to the target business function. The business element component association table comprises a primary key, the name of the business data table, a mapping relationship between Chinese names and English names of field names, and an association relationship between field types and function components. A business primary key is a field in a database table with business logic meaning. The business primary key is for example a business identifier (ID for short).

As shown in FIG. 2b, obtaining the business element component association table by filling an association template according to an association relationship between data elements contained in a business data table and function components comprises the following steps

step 211, generating a business identifier according to the target business function;

step 212, filling the business identifier at a position in the association template corresponding to the business identifier;

step 213, obtaining a name of the business data table;

step 214, establishing association between a first language expression and a second language expression of the name of the business data table in the association template; and

step 215, establishing an association relationship between function components and data elements contained in the business data table in the association template to obtain the business element component association table.

By inputting a data element and a function component for generating a target business function page, using an association relationship between data elements and function components to fill a business element component association table, and then automatically generating the target business function page corresponding to a target business function according to the business element component association table, the embodiment of this application may effectively reduce the development cost of generating business function page.

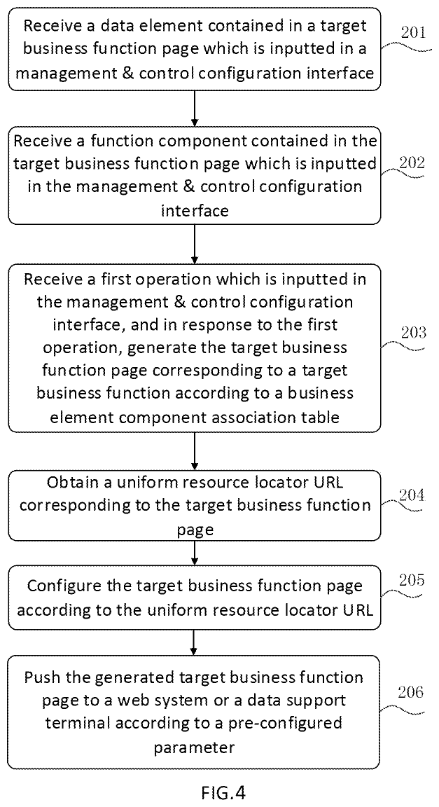

On the basis of the above embodiments, an embodiment of this application further provides a method for generating a business function page. As shown in FIG. 4, FIG. 4 shows a flow diagram of a further method for generating a business function page proposed by an embodiment of this application. The method may be performed by an apparatus for generating a business function page, and the apparatus for generating a business function page may be configured in a server. The method comprises:

step 201, receiving a data element contained in a target business function page which is inputted;

step 202, receiving a function component contained in the target business function page which is inputted;

step 203, receiving a first operation which is inputted, and in response to the first operation, generating the target business function page corresponding to a target business function according to a business element component association table;

wherein the data element, the function component and the first operation received at the above individual steps may be inputted in a management and control configuration interface as shown in FIG. 3, and

wherein the business element component association table is obtained by filling an association template according to an association relationship between data elements contained in a business data table and function components, and the business data table is generated according to the data elements;

step 204, obtaining a uniform resource locator URL corresponding to the target business function page;

step 205, configuring the target business function page according to the uniform resource locator URL; and

step 206, pushing the generated target business function page to a web system or a data support terminal according to a pre-configured parameter.

In the above embodiment, after performing according to a manner as shown in FIG. 2a on the management and control configuration interface shown on the front end of the management and control platform, the server feeds a uniform resource locator (URL for short) corresponding to the target business function page back to the front end of the management and control platform.

The front end of the management and control platform configures the target business function page according to the URL, namely, establishing a mapping relationship between the target business function page and a management interface of a branch of some intelligent bank which is to be generated, such that when the user inputs an operation on the management and control configuration interface with respect to the target business function, the target business function page corresponding to the target business function is obtained according to the URL in response to the operation.

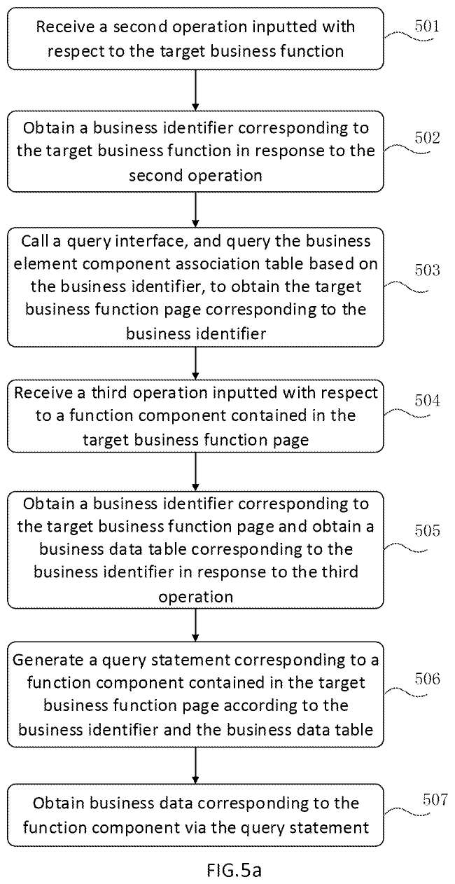

On the basis of the above embodiment, after generating the target business function page according to the business element component association table, an embodiment of this application further provides a method for applying a target business function page. As shown in FIG. 5a, FIG. 5a shows a flow diagram of a method for applying a target business function page proposed by an embodiment of this application. The method comprises:

step 501, receiving a second operation inputted with respect to the target business function;

step 502, obtaining a business identifier corresponding to the target business function in response to the second operation;

step 503, calling a query interface, and querying the business element component association table based on the business identifier, to obtain the target business function page corresponding to the business identifier;

step 504, inputting a third operation with respect to a function component contained in the target business function page;

step 505, obtaining a business identifier corresponding to the target business function page and obtaining a business data table corresponding to the business identifier in response to the third operation;

step 506, generating a query statement corresponding to a function component contained in the target business function page according to the business identifier and the business data table; and

step 507, obtaining business data corresponding to the function component via the query statement.

At the above steps, the user may perform a call operation through the target business function page after the target business function page is generated. For example, a second operation is inputted on a management interface of some branch of an intelligent bank with respect to a business function, and the second operation comprises, but is not limited to, a click operation, a touch operation, or a voice control operation, or the like. A business identifier corresponding to the target business function is obtained in response to the second operation; and a query interface is called to query the business element component association table based on the business identifier, to obtain the target business function page corresponding to the business identifier and show the target business function page on the front end. The user may further input a third operation with respect to a business function contained in the target business function page, and the third operation comprises, but is not limited to, a click operation, a touch operation or a voice control operation, or the like. A business identifier corresponding to the target business function page is obtained and a business data table corresponding to the business identifier is obtained, in response to the third operation; and then, a query statement corresponding to a function component contained in the target business function page is generated according to the business identifier and the business data table. At step 511, according to a table name of the business data table, a field attribute parameter of a database corresponding to the table name is obtained, and at step 512, a query statement corresponding to the function component is generated according to the field attribute parameter, as shown in FIG. 5b.

As an example, a second operation is inputted with respect to a query paging component, a name of a business data table in a corresponding business element component association table is found through a business identifier in response to the second operation, a corresponding field name is found according to the name of the business data table, for example, a field attribute parameter such as a corresponding database field name, is there a search condition, is it displayed in a list, or the like, a corresponding paging sql statement is generated according to the field attribute parameter, for example, select id (primary key id), name, address where name like “%name%” limit 1, 10, and business data is obtained through the paging sql statement.

As another example, a second operation is inputted with respect to a view details component, a name of a business data table in a corresponding business element component association table is found through a business identifier in response to the second operation, a corresponding field name is found according to the name of the business data table, for example, a corresponding database field name and a business data identifier, a corresponding query sql statement is generated, and business data corresponding to the view details component is obtained.

As another example, a second operation is inputted with respect to an add component, a name of a business data table in a corresponding business element component association table is found through a business identifier in response to the second operation, a corresponding field name is found according to the name of the business data table, for example, a corresponding database field name and json data of the front end, the corresponding database field name is matched according to the json data, and a corresponding insert statement is generated.

As another example, a second operation is inputted with respect to an edit component, a name of a business data table in a corresponding business element component association table is found through a business identifier in response to the second operation, a corresponding field name is found according to the name of the business data table, for example, a corresponding database field name and json data of the front end, the corresponding database field name is matched according to the json data, and a corresponding update statement is generated.

As another example, a second operation is inputted with respect to an examination and approval component, an examination and approval type in a corresponding business element component association table is found through a business identifier in response to the second operation, an examination and approval stream activity component and a business data identifier are determined according to the examination and approval type, to implement a function of the examination and approval component.

As another example, a second operation is inputted with respect to an upload and download component, which upload and download component may comprise two components, namely, an upload component and a download component, wherein the upload component finds relevant field data in a corresponding business element component association table according to a Chinese name of an uploaded file and a business identifier, then matches a database field name through the Chinese name, and generates a batch insert sql statement, and the download component finds relevant field data in a corresponding business element component association table according to a Chinese name of a downloaded file and a business identifier, then matches a database field name through the Chinese name, and generates a batch read sql statement.

As another example, a second operation is inputted with respect to a terminal component, a business identifier and a business data identifier are provided when needing business data in response to the second operation, and corresponding statements of query and push functions are generated.

As another example, a second operation is inputted with respect to a report component, field data related with a Chinese name in a corresponding business element component association table is found through the Chinese name and a business identifier in response to the second operation, a database field name is matched, and after successful matching by semantics, a corresponding conditional sql statement is generated. This requires a data rule to be filled in the management and control configuration interface, the data rule needs to comply with the sql specification, the Chinese name is consistent with an inputted Chinese name, data type matching needs to comply with a format, for example, Name=‘Student’, Department identifier ID=1.

In the embodiments of this application, during the operation with respect to the target business function page, the user may perform an operation in the target business function page with respect to a function component, and the operated function component queries a business element component association table through a business identifier to obtain relevant business data, which improves the accuracy of data query.

On the basis of the above embodiments, the method comprises:

pushing the generated target business function page to a web system or a data support terminal according to a pre-configured parameter.

An embodiment of this application further provides a wealth of application interfaces, and by a pre-configured parameter, for example, an interface attribute of the target business function page, implements showing of the target business function page in different platforms, and improves the operation efficiency of generating a page.

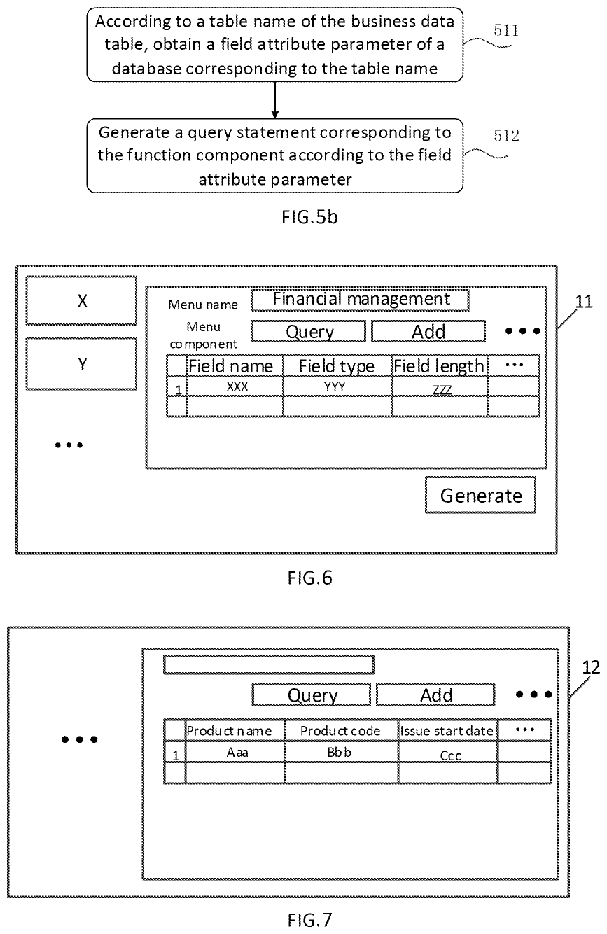

In the following, the description is further expanded in conjunction with FIG. 6 and FIG. 7 taking that a business function page corresponding to a financial management function is generated at some branch of an intelligent bank as an example.

A menu name inputted by the user in the management and control configuration interface 11 is financial management, the menu name represents a name corresponding to a business function, and the user expects that data elements contained in a financial management interface are a product name, a product code, an issue start date, an issue deadline, a product risk level, etc. The user configures data elements such as a field name, a field type, field length, etc. one by one in the management and control configuration interface shown in FIG. 6 according to desired configuration parameters, and afterwards, the server will generate the business data table according to the data elements inputted by the user.

The user may further input function components that a financial management interface is expected to contain in the management and control configuration interface 11, for example, a query component, an add component, a delete component, a paging component, etc.

A click operation inputted by the user with respect to a “generate” component is received in the management and control configuration interface 11, and a financial management interface 12 is generated according to a business element component association table, as shown in FIG. 7.

By establishing a business element component association table to implement pages of different business scenarios corresponding to business functions, the embodiment of this application effectively improves the efficiency of page development, and saves human resources.

The flow charts and block diagrams in the drawings illustrate system architectures, functions and operations that may be implemented by the system, method and computer program product of the various embodiments of this disclosure. In this respect, each box in the flow charts or block diagrams may represent a portion of a code, a program segment, or a module, and the portion of the code, the program segment, or the module contains one or more executable instruction for implementing a specified logic function. It should also be noted that in some alternative implementations, functions marked in boxes may also take place in an order other than those marked in the drawings. For example, two successively marked boxes may in fact be implemented basically in parallel, and they sometimes may also be implemented in a reverse order, which depends on the to involved function. It should also be noted that each box in the block diagrams and/or flow charts and a combination of boxes in the block diagrams and/or flow charts may be implemented by a dedicated hardware-based system for implementing a specified function or operation instruction, or may be implemented by a combination of dedicated hardware and computer instructions.

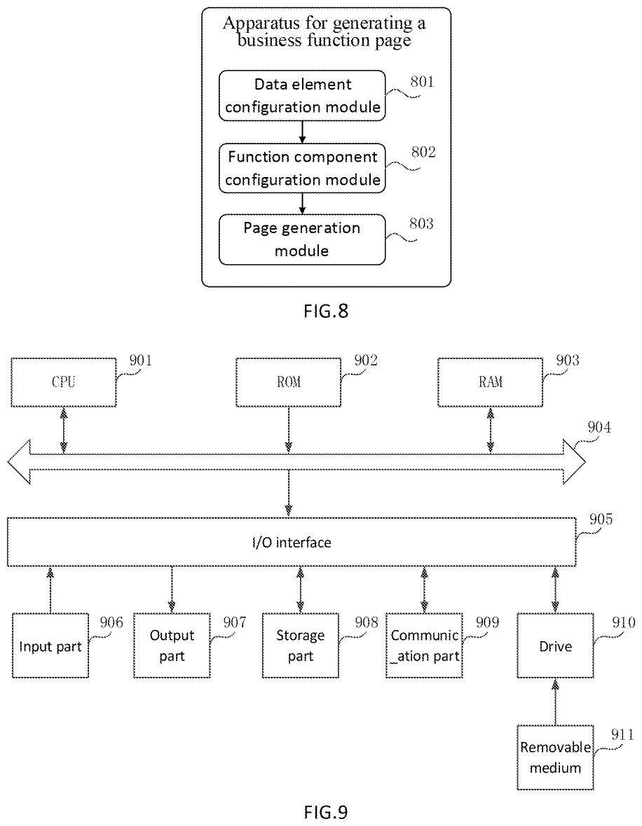

In the following, reference is made to FIG. 8, which shows a structure diagram of an apparatus for generating a business function page provided by an embodiment of this application. The apparatus may be configured in a server. The apparatus comprises:

a data element configuration module 801 for receiving a data element contained in a target business function page which is inputted;

a function component configuration module 802 for receiving a function component contained in the target business function page which is inputted; and

a page generation module 803 for receiving a first operation which is inputted, and in response to the first operation, generating the target business function page corresponding to a target business function according to a business element component association table.

The business element component association table is obtained by filling an association template according to an association relationship between data elements contained in a business data table and function components, and the business data table is generated according to the data elements.

The apparatus further comprises:

an association table filling module for filling an association template according to an association relationship between data elements contained in a business data table and the function components to obtain a business element component association table.

The association table filling module is further used for:

generating a business identifier according to the target business function;

filling the business identifier at a position in the association template corresponding to the business identifier;

obtaining a name of the business data table;

establishing association between a first language expression and a second language expression of the name of the business data table in the association template; and

establishing an association relationship between function components and data elements contained in the business data table in the association template to obtain the business element component association table.

The apparatus further comprises:

an obtaining module for obtaining a uniform resource locator URL corresponding to the target business function page; and

a configuration module for configuring the target business function page according to the uniform resource locator URL.

The apparatus further comprises:

an operation receiving module for receiving a second operation inputted with respect to the target business function;

an identifier obtaining module for obtaining a business identifier corresponding to the target business function in response to the second operation; and

a query module for calling a query interface, and querying the business element component association table based on the business identifier, to obtain the target business function page corresponding to the business identifier.

The apparatus further comprises:

an operation receiving module for receiving a third operation inputted with respect to a function component contained in the target business function page;

a data table obtaining module for obtaining a business identifier corresponding to the target business function page and a business data table corresponding to the business identifier in response to the third operation;

a query statement generation module for generating a query statement corresponding to a function component contained in the target business function page according to the business identifier and the business data table; and

a business data obtaining module for obtaining business data corresponding to the function component via the query statement.

The query statement generation module is further used for, according to a table name of the business data table, obtaining a field attribute parameter of a database corresponding to the table name, and generating a query statement corresponding to the function component according to the field attribute parameter.

The apparatus further comprises a business data table generation module for generating the business data table according to the data elements.

The business data table generation module is further used for:

creating a table name of the business data table according to the name of the target business function; and

creating a field name, a field type, a search attribute identifier, and a display attribute identifier in the business data table.

The apparatus further comprises a push configuration module for pushing the generated target business function page to a web system or a data support terminal according to a pre-configured parameter.

It should be appreciated that the various units or modules recorded in the above apparatus correspond to the various steps in the method described with reference to FIG. 2a. Therefore, the operations and features described with respect to the method equally apply to the apparatus and the units contained therein, which will not be repeated here any longer. The apparatus may pre-implemented in a browser or other security applications of an electronic device, or also may be loaded by way of download or the like into the browser or other security applications of the electronic device. Corresponding units in the apparatus may cooperate with units in the electronic device to realize the schemes of the embodiments of this application.

Several modules or units are mentioned in the above detailed description, and such a division is not mandatory. In fact, according to an implementation of this disclosure, features and functions of two or more modules or units described in the above may be embodied in one module or unit. On the contrary, features and functions of one module or unit described in the above may further be divided to be embodied by multiple modules or units.

In the following, with reference to FIG. 9, FIG. 9 shows a structure diagram of a processing system of an electronic device provided by an embodiment of this application.

As shown in FIG. 9, a computer system comprises a central processing unit (CPU) 901, which may perform various suitable actions and processing according to a program stored in a read-only memory (ROM) 902 or a program loaded from a storage part 908 to a random access memory (RAM) 903. Various programs and data required for operations are further stored in the RAM 903. The CPU 901, the ROM 902 and the RAM 903 are coupled to each other via a bus 904. An input/output (I/O) interface 905 is also connected to the bus 904.

The following components are connected to the I/O interface 905: an input part 906 comprising a keyboard, a mouse, etc.; an output part 907 comprising for example a cathode ray tube (CRT), a liquid crystal display (LCD), etc. and a speaker, etc.; a storage part 908 comprising a hard disk, etc.; and a communication part 909 comprising a network interface card such as a LAN card, a modem, etc. The communication part 909 performs communication processing via a network such as Internet. A drive 910 is also connected to the I/O interface 905 as needed. A removable medium 911 such as a magnetic disk, an optical disk, a magneto-optical disk, a semiconductor device or the like is installed on the drive 910 as needed, in order that a computer program read out from it is installed into the storage part 908 as needed.

In particular, according to an embodiment of this disclosure, the processes described above with reference to the flow charts FIGS. 2a-5 may be implemented as a computer software program. For example, an embodiment of this disclosure comprises a computer program product comprising a computer program carried on a machine readable medium, which computer program contains program codes for implementing a method as shown in a flow chart. In such an embodiment, the computer program may be downloaded and installed from a network by the communication part 909, and/or installed from the removable medium 911. When executed by the central processing unit (CPU) 901, the computer program implements the above functions defined in the system of this application.

It needs to be noted that the computer readable medium illustrated in this disclosure may be a computer readable signal medium or a computer readable storage medium or any combination of the two. The computer readable storage medium may be for example, but not limited to, an electric, magnetic, optical, electromagnetic, infrared or semiconductor system, apparatus or device, or any combination thereof. More specific examples of the computer readable storage medium may comprise, but are not limited to, an electrical connection with one or more wire, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In this disclosure, the computer readable storage medium may be any tangible medium containing or storing a program, which program may be used by or in combination with an instruction execution system, apparatus or device. In this disclosure, the computer readable signal medium may comprise a data signal propagated in a baseband or as part of a carrier wave, with a computer readable program code carried thereon. Such a propagated data signal may take a variety of forms, comprising but not limited to an electromagnetic signal, an optical signal or any suitable combination thereof. The computer readable signal medium may further be any computer readable medium other than the computer readable storage medium, which may send, propagate or transmit a program for being used by or in combination with the instruction execution system, apparatus or device. The program code comprised in the computer readable medium may be transmitted by any suitable medium, comprising but not limited to wireless, wire, cable, RF, etc., or any suitable combination thereof.

The flow charts and block diagrams in the drawings illustrate system architectures, functions and operations that may be implemented by the system, method and computer program product according to the various embodiments of this disclosure. In this respect, each box in the flow charts or block diagrams may represent a portion of a code, a program segment, or a module, and the portion of the code, the program segment, or the module contains one or more executable instruction for implementing a specified logic function. It should also be noted that in some alternative implementations, functions marked in boxes may also take place in an order other than those marked in the drawings. For example, two successively marked boxes may in fact be implemented basically in parallel, and they sometimes may also be implemented in a reverse order, which depends on the involved function. It should also be noted that each box in the block diagrams and/or flow charts and a combination of boxes in the block diagrams and/or flow charts may be implemented by a dedicated hardware-based system for implementing a specified function or operation instruction, or may be implemented by a combination of dedicated hardware and computer instructions.

An involved unit or module described in an embodiment of this application may be implemented by way of software, or also may be implemented by way of hardware. The described units or modules may also be arranged in a processor, which for example may be described as: a processor comprising a data element configuration module, a function component configuration module and a page generation module. Therein, in some case, the names of these units or modules do not constitute a limitation to the units or modules themselves. For example, the data element configuration module may further be described as “a module for receiving a data element contained in a target business function page which is inputted”.

On the other hand, this application further provides a computer readable storage medium, which may be one contained in an electronic device described in the above embodiments, or also may be one which is stand-alone and is not assembled into the electronic device. The computer readable storage medium stores one or more program, which is run by one or more processor to perform a method for a business function page described in this application.

By generating a target business function page corresponding to a target business function via a business element component association table, the embodiments of this application effectively increase the development efficiency of a page and improve the versatility of business development.

What is described above is just the preferable embodiments of the application and the illustration of the applied technical principles. It should be appreciated by the person having ordinary skills in the art that the scope of the disclosure involved in this application is not limited to technical solutions formed by specific combinations of the above technical features, and at the same time, should also encompass other technical solutions formed by any combinations of the above technical features or their equivalent features, without departing from the concepts of the disclosure, for example, technical solutions formed by the above features and technical features (not limited thereto) disclosed in the application and having similar functions replacing each other.

1. A method for a business function page comprising:
receiving a data element contained in a target business function page which is inputted;
receiving a function component contained in the target business function page which is inputted; and
receiving a first operation which is inputted, and in response to the first operation, generating the target business function page corresponding to a target business function according to a business element component association table, the business element component association table being obtained by filling an association template according to an association relationship between a data element contained in a business data table and the function component, and the business data table being generated according to the data element.

2. The method as claimed in claim 1, wherein obtaining the business element component association table by filling the association template according to the association relationship between a data element contained in the business data table and the function component comprises:
generating a business identifier according to the target business function;
filling the business identifier at a to-be-filled position in the association template corresponding to the business identifier;
obtaining a name of the business data table;
establishing association between a first language expression and a second language expression of the name of the business data table in the association template; and
establishing an association relationship between the function component and the data element contained in the business data table in the association template to obtain the business element component association table.

3. The method as claimed in claim 1, wherein after generating the target business function page according to the business element component association table, the method further comprises:
obtaining a uniform resource locator corresponding to the target business function page; and
configuring the target business function page according to the uniform resource locator.

4. The method as claimed in claim 1, wherein after generating the target business function page according to the business element component association table, the method further comprises:
receiving a second operation inputted with respect to the target business function;
obtaining a business identifier corresponding to the target business function in response to the second operation; and
calling a query interface, and querying the business element component association table based on the business identifier, to obtain the target business function page corresponding to the business identifier.

5. The method as claimed in claim 4, wherein after obtaining the target business function page corresponding to the business identifier, the method further comprises:
receiving a third operation inputted with respect to a function component contained in the target business function page;
obtaining the business identifier and a business data table corresponding to the business identifier in response to the third operation;
generating a query statement corresponding to the function component contained in the target business function page according to the business identifier and the business data table; and
obtaining business data corresponding to the function component via the query statement.

6. The method as claimed in claim 5, wherein generating a query statement corresponding to the function component according to the business data table comprises:
according to a table name of the business data table, obtaining a field attribute parameter of a database corresponding to the table name; and
generating the query statement corresponding to the function component according to the field attribute parameter.

7. The method as claimed in claim 1, wherein generating the business data table according to the data element comprises:
creating a table name of the business data table according to a name of the target business function; and
creating at least one of a field name, a field type, a search attribute identifier, or a display attribute identifier in the business data table.

8. The method as claimed in claim 1, wherein the method comprises:
pushing the generated target business function page to a web system or a data support terminal according to a pre-configured parameter.

9. The method as claimed in claim 1, wherein the received data element, function component and first operation may be inputted in a management and control configuration interface.

10. An electronic device comprising a memory, a processor, and a computer program which is stored on the memory and may be run on the processor, wherein when executing the computer program, the processor implements the method as claimed in claim 1.

11. The electronic device as claimed in claim 10, wherein when executing the computer program, the processor implements: obtaining the business element component association table by filling the association template according to the association relationship between the data element contained in the business data table and the function component, comprising:
generating a business identifier according to the target business function;
filling the business identifier at a to-be-filled position in the association template corresponding to the business identifier;
obtaining a name of the business data table;
establishing association between a first language expression and a second language expression of the name in the association template; and
establishing an association relationship between the function component and the data element contained in the business data table in the association template to obtain the business element component association table.

12. The electronic device as claimed in claim 10, wherein when executing the computer program, the processor implements: after generating the target business function page according to the business element component association table,
obtaining a uniform resource locator corresponding to the target business function page; and
configuring the target business function page according to the uniform resource locator.

13. The electronic device as claimed in claim 10, wherein when executing the computer program, the processor implements: after generating the target business function page according to the business element component association table,
receiving a second operation inputted with respect to the target business function;
obtaining a business identifier corresponding to the target business function in response to the second operation; and
calling a query interface, and querying the business element component association table based on the business identifier, to obtain the target business function page corresponding to the business identifier.

14. The electronic device as claimed in claim 13, wherein when executing the computer program, the processor implements: after obtaining the target business function page corresponding to the business identifier,
receiving a third operation inputted with respect to a function component contained in the target business function page;
obtaining the business identifier and a business data table corresponding to the business identifier in response to the third operation;
generating a query statement corresponding to the function component contained in the target business function page according to the business identifier and the business data table; and
obtaining business data corresponding to the function component via the query statement.

15. The electronic device as claimed in claim 14, wherein when executing the computer program, the processor implements: generating a query statement corresponding to the function component according to the business data table, comprising:
according to a table name of the business data table, obtaining a field attribute parameter of a database corresponding to the table name; and
generating the query statement corresponding to the function component according to the field attribute parameter.

16. The electronic device as claimed in claim 10, wherein when executing the computer program, the processor implements: generating the business data table according to the data element, comprising:
creating a table name of the business data table according to a name of the target business function; and
creating at least one of a field name, a field type, a search attribute identifier, or a display attribute identifier in the business data table.

17. The electronic device as claimed in claim 10, wherein when executing the computer program, the processor implements:
pushing the generated target business function page to a web system or a data support terminal according to a pre-configured parameter.

18. The electronic device as claimed in claim 10, wherein the received data element, function component and first operation may be inputted in a management and control configuration interface.

19. A computer readable storage medium storing a computer program thereon, when executed by a processor, the computer program implementing the method as claimed in claim 1.
